(19) United States
(12) Patent Application Publication
(10) Pub. No.: US 2015/0160790 A1
(43) Pub. Date: Jun. 11, 2015

(54) WINDOW INTERFACE DISPLAY METHOD AND SYSTEM

(71) Applicant: Alibaba Group Holdings Limited, Grand Cayman (KY)

(72) Inventors: Jingxiong Tang, Hangzhou (CN); Jieyu Li, Hangzhou (CN); Linfeng Lu, Hangzhou (CN)

(21) Appl. No.: 14/564,535

(22) Filed: Dec. 9, 2014

(30) Foreign Application Priority Data
Dec. 10, 2013 (CN) 201310666451.4

(51) Int. Cl. G06F 3/0481

(52) U.S. Cl. CPC G06F 3/0481

(57) ABSTRACT

Window interface display method and system are disclosed. The window interface display method comprises: receiving a request for creating a first window, the request including type information of a window to be created and information of a data source to be loaded; determining sub-regions included in the window to be created based on the type information, wherein the sub-regions include a public region and a characteristic region, the public region includes a same portion of at least two different types of windows, and the characteristic region includes a characteristic portion of each specific type of window that is different from other types of window; loading respective control sets corresponding to the sub-regions of the first window to be created and respective data sources corresponding to the sub-regions; and displaying a result of the loading. By using this technical solution, a code structure of an entire window system is clearer and more concise, and can effectively reduce development and maintenance costs, avoid loading the same content repeatedly, improve the operation efficiency of a program, and reduce the occupancy of system resources.

### CROSS REFERENCE TO RELATED PATENT APPLICATION

This application claims foreign priority to Chinese Patent Application No. 201310666451.4 filed on Dec. 10, 2013, entitled “Window Interface Display Method and System”, which is hereby incorporated by reference in its entirety.

### BACKGROUND

Windows are basic components of a Graphical User Interface (GUI), and are configured to provide interfaces for interaction between users and application programs. A user can view information in a window, or click a control, such as a button and a menu, etc., in the window to implement an operation of an application program.

During execution of an application program, one or more windows may need to be created to implement corresponding functions. Each window is made up of a number of different types of controls, and windows having different functions correspond to different construction schemes of controls. According to implementations of existing technologies, a window of each function corresponds to one classification, and a set of control types needed by the window is defined in that classification. When an application program needs to display a window, all controls in that window are created and displayed once as a whole. If a window of another function is needed to be displayed, a new control set is needed to be created and displayed for a classification corresponding to the new window.

However, in a real application, although some windows may have different functions, conditions of constructing actual controls are mostly the same. For a solution adopting the existing technologies, when a new function window needs to be displayed, a complete window classification is needed to be created again, which definitely imposes negative influence on the efficiency of program operations and the occupancy of system resources. In addition, for developers, if multiple window classifications are developed due to few differences in controls, a great number of codes are repeated, thus increasing the development and maintenance costs.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In order to solve the above technical problem, embodiments of the present application provide a method and a system of displaying a window interface, so as to improve the display performance of the window interface, and reduce the development cost. The technical solution is described as follows.

An embodiment of the present application provides a window interface display method, and the method comprises:

receiving a request for creating a first window, the request including type information of a window to be created and information of a data source to be loaded;

determining sub-regions included in the window to be created based on the type information, wherein the sub-regions include a public region and a characteristic region, the public region includes a same portion of at least two different types of windows, and the characteristic region includes a characteristic portion of each specific type of window that is different from other types of window;

loading respective control sets corresponding to the sub-regions of the first window to be created and respective data sources corresponding to the sub-regions; and

displaying a result of the loading.

An embodiment of the present application further provides a window interface display system, and the system includes:

a creation request receiving module, configured to receive a request for creating a first window, the request including type information of a window to be created and information of a data source to be loaded;

a sub-region determination module, configured to determine sub-regions included in the window to be created based on the type information, wherein the sub-regions include a public region and a characteristic region, the public region includes a same portion of at least two different types of windows, and the characteristic region includes a characteristic portion of each specific type of window that is different from other types of window;

a first loading module, configured to load respective control sets corresponding to the sub-regions of the first window to be created and respective data sources corresponding to the sub-regions; and

a display module, configured to display a loading result of the first loading module.

In the technical solution provided in the embodiments of the present application, a window is divided into multiple sub-regions, wherein a public region is defined as a same part of at least two different types of windows. In other words, multiple types of windows exist with these types of windows using a same control set of the public region. In this way, from the perspective of a developer, only a single copy of codes associated with a public region is needed to be maintained for multiple types of windows, and only the portion associated with a non-public region is needed to be considered for development and maintenance of a specific type of window. Compared with the existing technologies, a code structure of the entire window system is clearer and more concise, thus effectively reducing the development and maintenance costs.

In addition, when different types of windows are displayed in a switching or replacing manner, a public region control set of the windows may be loaded once, so as to avoid repeatedly loading the same content, thereby improving the efficiency of program operations and reducing the occupancy of system resources.

### BRIEF DESCRIPTION OF THE DRAWINGS

In order to describe the embodiments of the present application or the technical solution in the existing technologies more clearly, accompanying drawings needed in the descriptions of the embodiments or the existing technologies are briefly described herein. Apparently, the accompanying drawings described herein are merely some embodiments in the present application. One of ordinary skill in the art can obtain other accompanying drawings based on these accompanying drawings.

FIG. 1 is a schematic diagram illustrating region division of a single chat window according to an embodiment of the present application.

FIG. 2 is a schematic diagram illustrating region division of a group chat window according to an embodiment of the present application.

FIG. 3 is a first flow chart illustrating a method of displaying a window interface according to an embodiment of the present application.

FIG. 4 is a second flow chart illustrating a method of displaying a window interface according to an embodiment of the present application.

FIG. 5 is a third flow chart illustrating a method of displaying a window interface according to an embodiment of the present application.

FIG. 6 is a fourth flow chart illustrating a method of displaying a window interface according to an embodiment of the present application.

FIG. 7 is a first structural diagram illustrating an apparatus of displaying a window interface according to an embodiment of the present application.

FIG. 8 is a second structural diagram illustrating an apparatus of displaying a window interface according to an embodiment of the present application.

FIG. 9 is a structural diagram illustrating an apparatus described in FIGS. 7 and 8 in further details.

### DETAILED DESCRIPTION

According to the descriptions of the existing technologies, actual conditions for constructing controls are mostly the same, though some windows have different functions in a real application. Based on this characteristic, a scheme of the present application extracts a same portion of multiple types of windows, which is called a “public region”. From the perspective of controls, respective control information that is loaded by each type of window may be considered as different sets, and the “control information” herein includes a type, a layout, a specific parameter configuration, etc., of a control. A control set corresponding to the public region is an intersection of these sets. In other words, different types of windows have a same public region control set. In a real application, the public region is mainly used to display general data of a window service, and provide a general operation interface for basic services. A single public region control set can be used by multiple kinds of window services.

Corresponding to the public region, the solution of the present application further defines a “characteristic region” in the window, that is, a characteristic part of each specific type of window that is different from other types of window. The characteristic region also has a corresponding control set, and different types of windows have respective characteristic region control sets. In a real application, the characteristic region is mainly used for displaying characteristic data of a window service, and provides an operation interface for a characteristic service. Each characteristic region control set corresponds to a specific window service.

It can be understood that, the “different types of windows” described in the embodiments of the present application may be directed to a certain specific scope, and in a real application, generally refer to windows that have similar but not completely identical functions in a certain application program. Examples include a single chat/group chat window in instant messaging software, an email receiving/email sending window in email client software, and editing windows for different file types, etc.

The public region and the characteristic region are basic components of a window. In other words, when a window is created, at least these two sub-regions of the window are created. In addition, during the use of some windows, a new region may need to be created at any time on the basis of a displayed window, so as to provide some extended functions, such as attaching a search interface on a chat window, attaching a contact selection interface on an email sending window, etc. In the embodiment of the present application, this region that provides an extended function is referred to as an “extended region”.

Similar to the public region and the characteristic region, the extended region also has a corresponding control set. In the specific scope as described above, an extended region control set corresponding to a specific function may be applicable to one type of window only, or may be applicable to multiple types of windows at the same time. For example, an extended region of “search interface” can be attached to a single chat window or a group chat window. The extended region is a dispensable component for a window. In a real application, an extended region is mainly used to display an interface belonging to an external service in a grafting manner, and provide a corresponding operation interface.

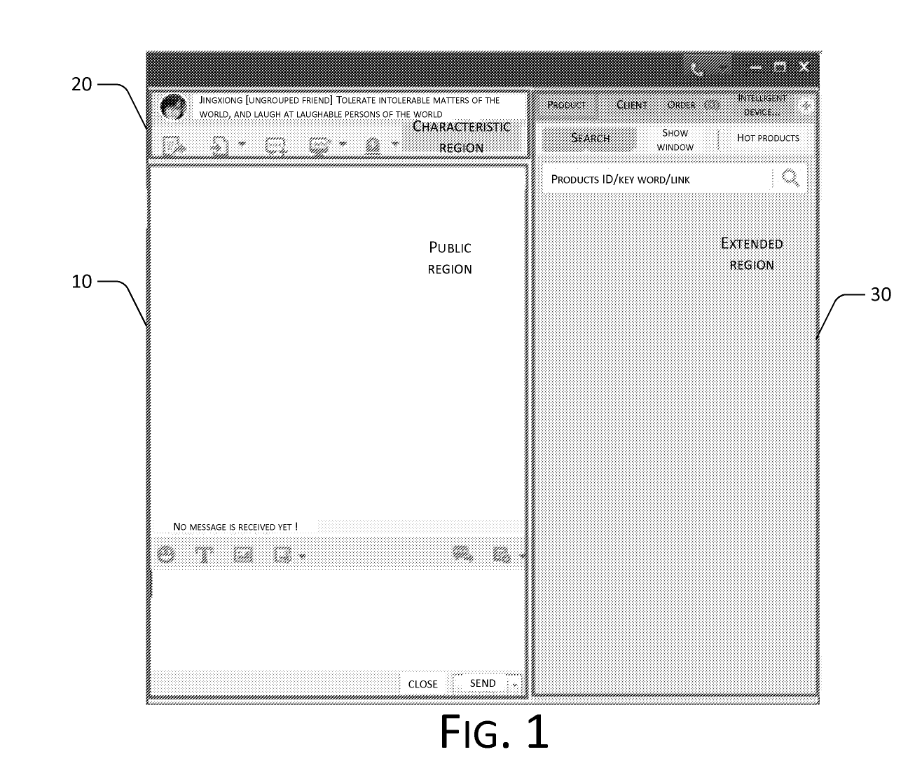

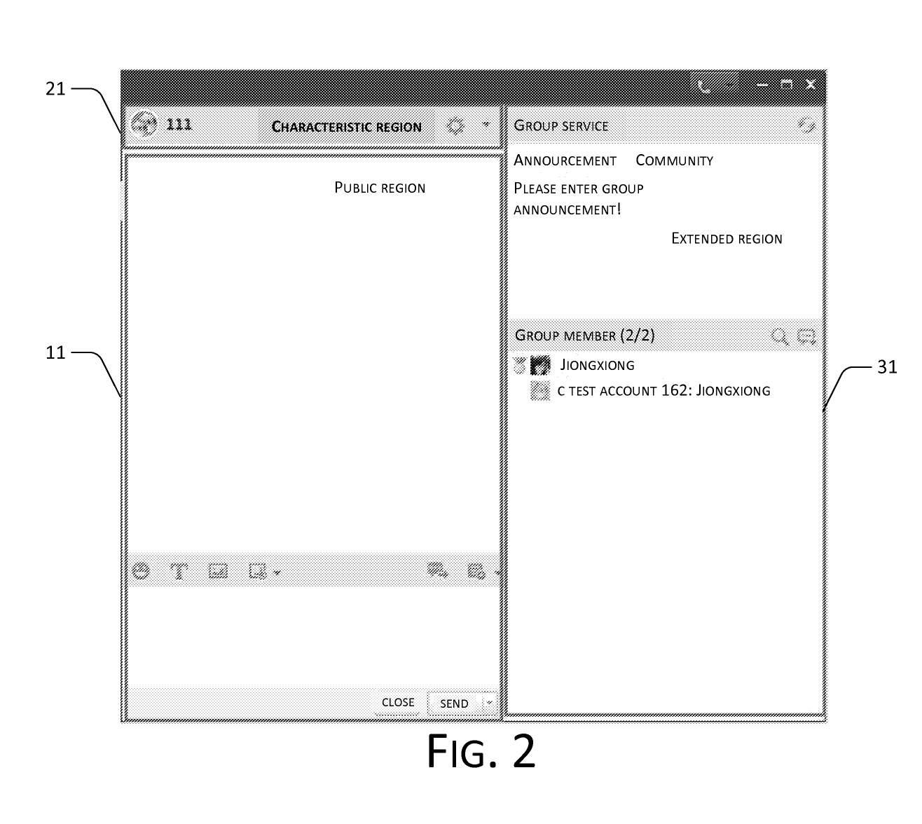

Instant messaging software is used as an example, FIG. 1 and FIG. 2 show schematic diagrams illustrating sub-region division of two types of windows in the instant messaging software respectively. A single chat window, as shown in FIG. 1, includes a public region 10, a characteristic region 20 and an extended region 30. A group chat window, as shown in FIG. 2, includes a public region 11, a characteristic region 21 and an extended region 31. As can be seen, configurations of controls of public regions in the two types of windows are the same, with a difference in data sources that need to be displayed (which correspond to different chatting records in this example). Control configurations of extended regions are different, and corresponding data sources that need to be displayed (which correspond to related information of a “personal use” and a “group” in this example) are also different. In addition, the two types of windows each have an extended region, as shown in FIG. 1 and FIG. 2. Configuration conditions associated with controls of the two extended regions and the data sources that need to be displayed are also totally different.

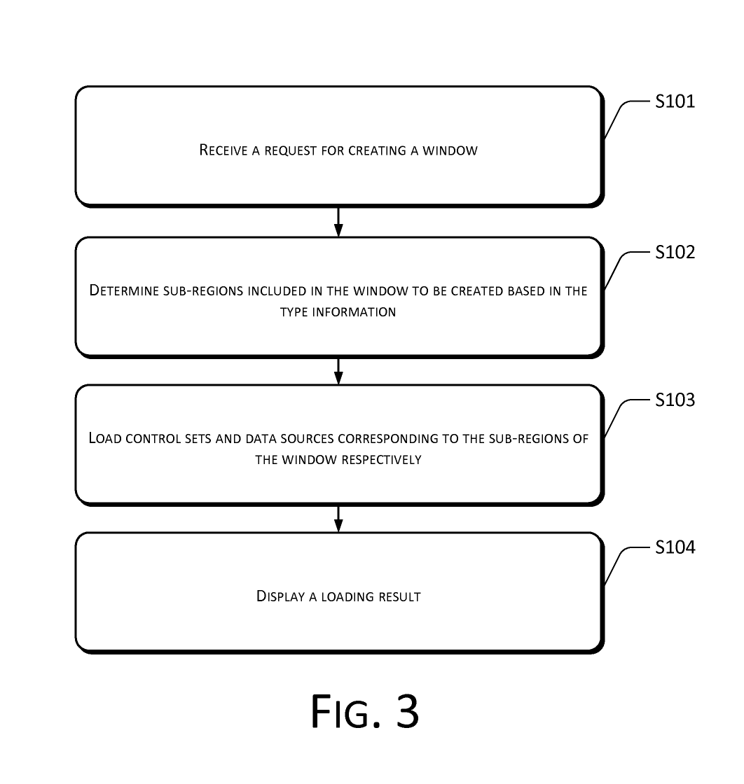

Based on the above division mechanism of a window's sub-regions, an embodiment of the present application provides an interface display method, as shown in FIG. 3. The method may include the following:

S101 receives a request for creating a window.

The window creation request includes type information of a window that is to be created and information of a data source that is to be loaded.

A creation of a single chat window during operation of instant messaging software is used as an example. After a user performs a corresponding operation (e.g., double clicks a profile picture of a friend in a buddy list), which is equivalent to sending a request for creating a window to a system, the system determines that a window of a “single chat” type needs to be created at the present time through analyzing the request, and further determines data source(s) that need(s) to be loaded, such as an ID of a chat object, a nickname, group information of buddies, a signature, a profile picture, chatting records, etc.

S102 determines sub-regions included in the window to be created based on the type information.

According to the solution of the present application, a public region and a characteristic region are essential components of a window. Therefore, at this block, at least a public region and a characteristic region associated with the window to be created need to be determined.

The creation of the single chat window is still used as an example for illustration. The system may determine what public region and what characteristic region (as shown by 10 and 20 in FIG. 1) need to be created correspondingly based on a “single chat” window type, and thereby determine which types of public region control set and characteristic region control set need to be loaded currently. In addition, for multiple data sources that are determined at block S101, a further determination is made as to which data source(s) need(s) to be located correspondingly for each region. For example, “chatting records” need to be loaded in the public region, and a nickname, group information of a buddy, a signature, a profile picture, etc., of a chat object need to be loaded in the characteristic region.

If the window that is to be created further includes an extended region, a further determination is made as to which type of extended region control set needs to be loaded currently, and a corresponding data source to be loaded is also determined.

It should be noted that, some windows may include an extended region. However, the extended region may not be displayed to a user at an initial stage of creation, but may rather be created or updated at any time according to service needs. Therefore, in a specific implementation of the present application, the system may determine whether an extended region is needed to be created at the current stage after receiving the window creation request, and may continuously monitor the need of creation of an extended region. Upon determining that an extended region needs to be created currently, a further determination is made as to which type of extended region control set and corresponding data source need to be loaded at the current time.

S103 loads control sets and data sources corresponding to the sub-regions of the window respectively.

Based on a determination result at block S102, the system performs the following loading operations respectively:

a) loading a public region control set, and further loading a data source corresponding to the public region;

b) loading a characteristic region control set, and further loading a data source corresponding to the characteristic region; and

c) if needed, loading an extended region control set, and further loading a data source corresponding to the extended region.

It can be understood that, no specific limitation is made for the order of execution associated with the operations of loading content of the three types of sub-regions. Apparently, in most situations, the extended region, as a dispensable component of a window, may be loaded after the completion of the loading of the public region and the characteristic region.

S104 displays a loading result.

Based on the above blocks, a nickname of a chat object is “Jiongxiong”, and a created single chat window is shown in FIG. 1. Since no historical chatting records exist, a corresponding part of the public region is displayed as blank.

Similarly, a group chat window, as shown in FIG. 2, may be created by performing blocks S101-104. Public region control sets of these two types of windows are the same, and a developer only needs to maintain a single copy of codes associated with the public region. As compared with the existing technologies, the number of codes is effectively reduced, and maintenance thereof is much simpler.

Based on the technical solution provided in the embodiment of the present application, if different types of windows need to be displayed in a switching or substitution manner during an operation of a program, a public region control set of these windows may be loaded only once, thereby avoiding loading the same content repeatedly, improving the operation efficiency of the program and reducing the occupancy of system resources.

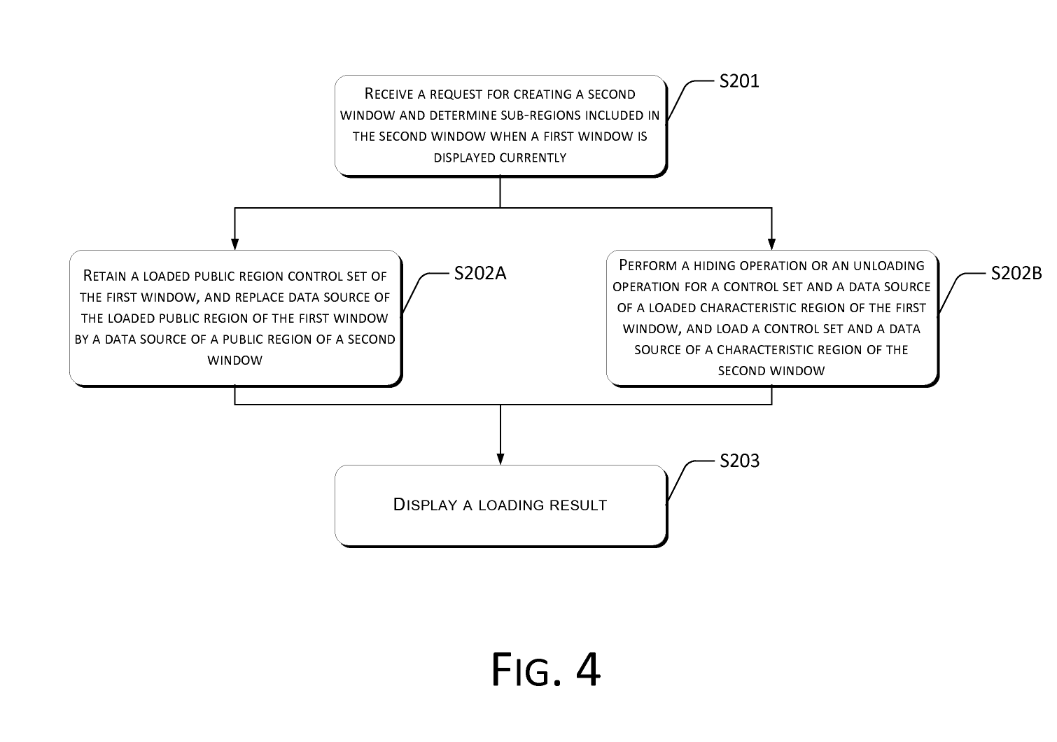

FIG. 4 is a schematic diagram illustrating a process of switching or replacing a window according to an embodiment of the present application, which includes the following:

S201 receives a request for creating a second window and determines sub-regions included in the second window when a first window is displayed currently.

S202a retains a loaded public region control set of the first window, and replaces data source of the loaded public region of the first window by a data source of a public region of a second window.

S202b performs a hiding operation or an unloading operation for a control set and a data source of a loaded characteristic region of the first window, and loads a control set and a data source of a characteristic region of the second window.

S203 displays a loading result.

The above process is described hereinafter using a specific example.

If a single chat window is currently displayed, the system further receives a request for creating a group chat window, and further determines sub-regions included in the group chat window.

If two types of chat windows are not allowed to be displayed simultaneously in a same user interface based on a setting of chatting software, the single chat window and the group chat window have a “switching” or “replacement” relationship with each other. The “switching” herein refers to a situation where the two windows are in a loading state at the same time, but only one window is displayed in a user interface, and a user may perform a quick switching between the two windows through means such as a label, a button etc., for browsing. The “replacement” herein refers to a situation that a second window is loaded and a first window is closed, and a user cannot return to the first window through a quick switching operation when browsing a newly displayed window.

At S202a, since the single chat window and the group chat window have a same public region control set, a loaded control set of a public region of the single chat window may be used no matter whether a current service need is “switching” or “replacement”. Only a data source for a public region of the group chat window needs to be loaded. The current example mainly describes loading chatting records corresponding to a group.

At S202b, a hiding operation or an unloading operation for a control set and a data source of a characteristic region of the single chat window is needed to be performed, and a control set and a data source of a characteristic region of the group chat window is loaded.

If the current service need is “switching”, a hiding operation is performed for the characteristic region of the single chat window, and specific implementation may include setting a size of the window to zero, or setting the window to transparent and un-selectable status, etc. The data source of the characteristic region of the single chat window is still maintained in a memory.

If the current service need is “replacement”, an unloading operation is performed for the characteristic region of the single chat window, and the loaded control set and data source of the characteristic region are released from the memory.

At S203, a result of reloading is displayed, and what is seen by the user is the group chat window as shown in FIG. 2. If the single chat window has a “switching” relationship with the group chat window, control sets and data sources of characteristic regions of two types of windows coexist in the memory after one switching is completed. Subsequently, the system may respond to a switching operation of the user rapidly.

It can be understood that no limitation is needed to be imposed on the order of executing S202a and S202b in this embodiment.

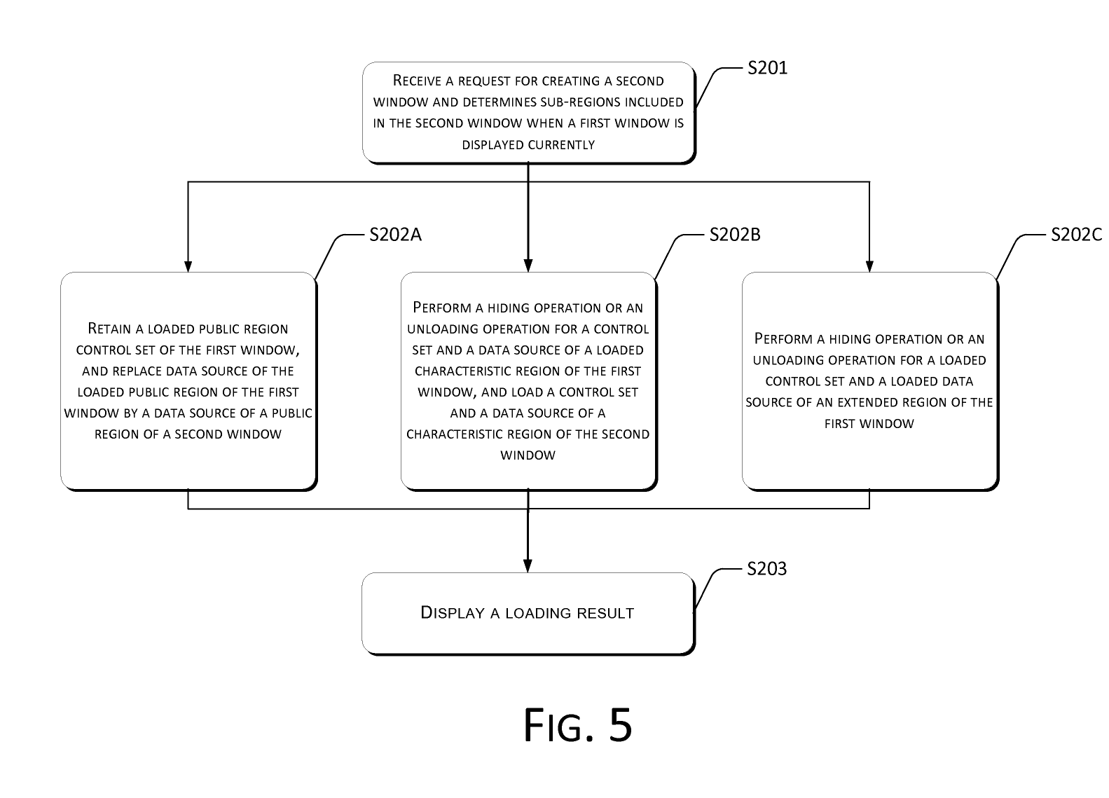

In the embodiment shown in FIG. 4, only two basic components of a window, a public region and a characteristic region, are taken into consideration. In a situation wherein an extended region of a loaded first window is currently displayed, an embodiment of the present application further provides a method of switching or replacement a window. As shown in FIG. 5, the method further includes:

S202c performs a hiding operation or an unloading operation for a loaded control set and a loaded data source of an extended region of the first window.

Similar to the operation for the characteristic region, if the current service need is “switching”, a hiding operation is performed for the extended region of the single chat window, and the data source of the extended region of the single chat window is still retained in the memory.

If the current service need is “replacement”, an unloading operation is performed for the extended region of the single chat window. The loaded control set and the loaded data source of the extended region are released from the memory.

After S202c is performed, a determination may further be made as to whether the second window that is to be created currently has a need of creating an extended region. Alternatively, monitoring is performed for a creation need of an extended region of the second window, and upon determining that an extended region is needed to be created currently, a loading operation is performed for a control set and a data source of the extended region of the second window.

It can be understood that no limitation is needed to be imposed on the order of executing S202a, S202b and S202c in this embodiment.

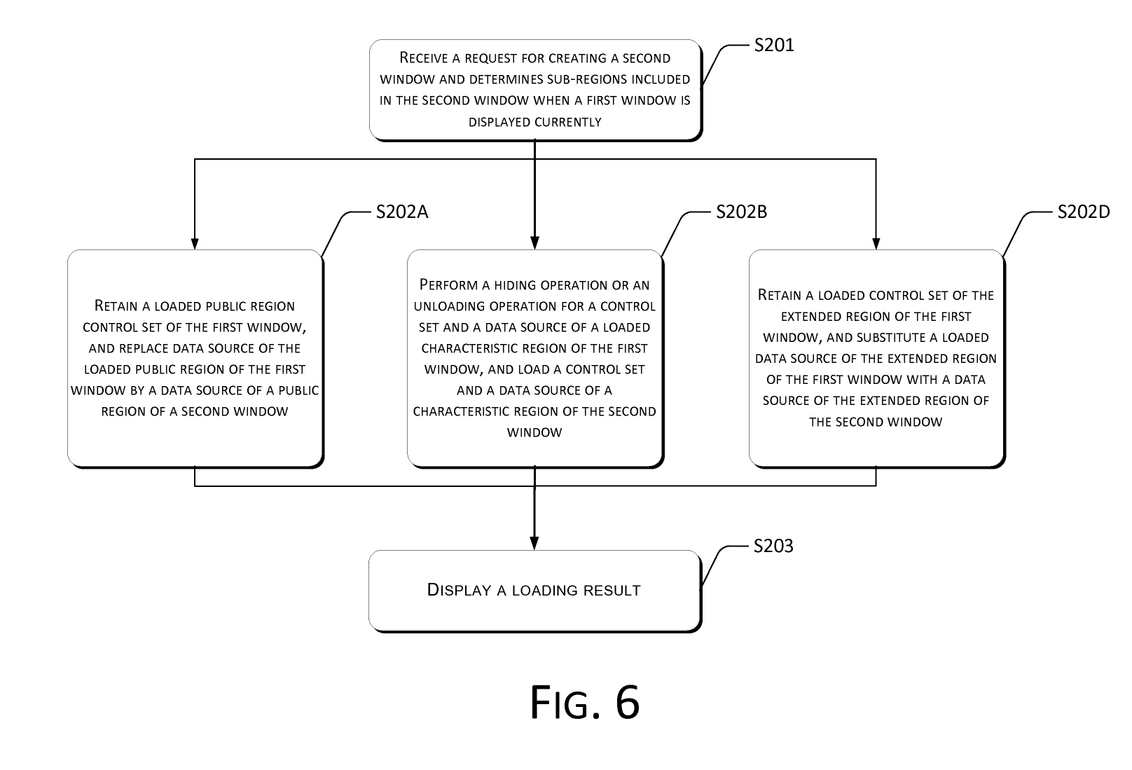

Based on the descriptions of the foregoing embodiments, an extended region control set that corresponds to specific function(s) may be applicable to various types of windows. Therefore, in a situation where an extended region of a first window is displayed, and a second window that is to be created uses a same extended region control set of the first window, loading of an extended region of a new window may be implemented by executing S202d, as shown in FIG. 6.

S202d retains a loaded control set of the extended region of the first window, and substitutes a loaded data source of the extended region of the first window with a data source of the extended region of the second window.

Since the first window and the second window have the same extended region control set, the loaded control set of the extended region of the first window may be used directly, and only the data source of the extended region of the second window is needed to be loaded.

It can be understood that no limitation is imposed on the order of executing S202a, S202b and S202d in the present embodiment.

As can be seen from the above embodiment, a window display system provided in the present application actually includes three window containers: a public region container, a characteristic region container and an extended region container. In a switching or replacement process of different types of windows, a control set of the public region container does not need to be loaded again, with only a data source being re-loaded. A control set and a data source of the characteristic region container both need to be loaded again. A loading operation in the extended region container depends on a specific situation: if two windows use a same extended region control set, a loading operation similar to the public region container is used; otherwise, a loading operation similar to the characteristic region container is used.

By using the technical solution provided in the embodiment of the present application, when different types of windows are displayed in a switching or substitution manner, a public region control set (and possibly an extended region control set) of these windows may be loaded for once, thereby avoiding loading the same content repeatedly, improving the operation efficiency of a program and reducing the occupancy of system resources.

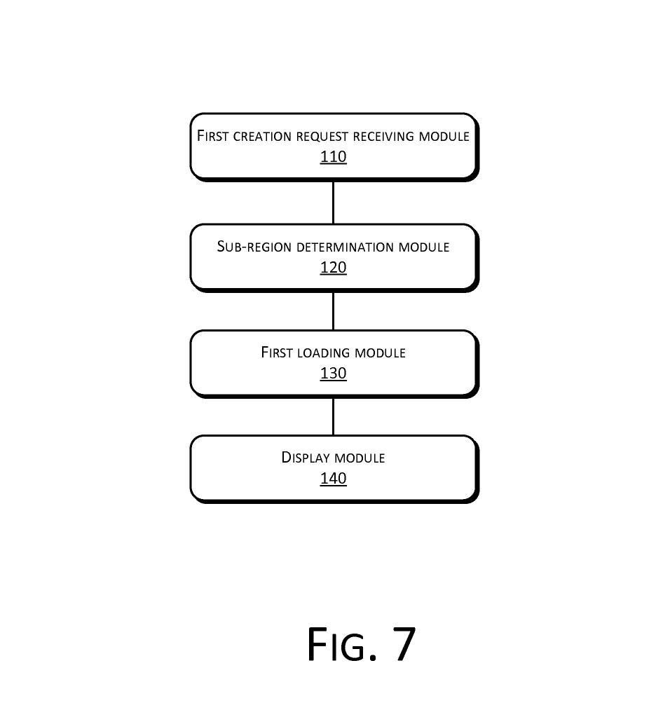

Corresponding to the above method embodiment, the present application further provides a system of displaying a window interface. As shown in FIG. 7, the system may include:

a creation request receiving module 110, configured to receive a request for creating a first window, the request including type information of a window to be created and information of a data source to be loaded;

a sub-region determination module 120, configured to determine sub-regions included in the window to be created based on the type information, wherein the sub-regions include a public region and a characteristic region, the public region includes a same portion of at least two different types of windows, and the characteristic region includes a characteristic portion of each specific type of window that is different from other types of window;

a first loading module 130, configured to load respective control sets corresponding to the sub-regions of the first window to be created and respective data sources corresponding to the sub-regions; and

a display module 140, configured to display a loading result of the first loading module.

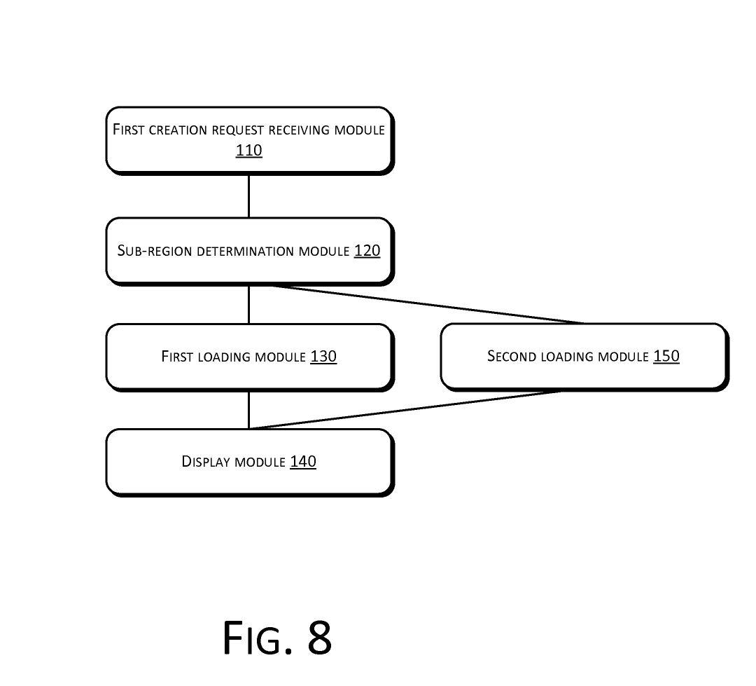

Referring to FIG. 8, according to a specific implementation of the present application, the window interface display system may further include a second loading module 150, configured to implement a function of window switching or replacement, wherein:

the creation request receiving module 110 is further configured to receive a request for creating a second window when the first window is displayed currently; and the display module 140 is further configured to display a loading result of the second loading module 150.

In a specific implementation of the present application, the second loading module 150 may specifically be configured to: retain a loaded control set of the public region of the first window, replace a loaded data source of the public region of the first window with a data source of a public region of the second window, perform a hiding operation or an unloading operation for a loaded control set and a loaded data source of the characteristic region of the first window, and load a characteristic control set and a data source of a characteristic region of the second window.

The second loading module 150 may determine whether the second window that is to be created has a switching or replacement relationship with the first window that is currently displayed based on a service requirement, hide the loaded control set and the loaded data source of the characteristic region of the first window if a switching relationship exists, and unloading the loaded control and the loaded data source of the characteristic region of the first window if a replacement relationship exists.

In a specific implementation of the present application, the second loading module 150 may further be configured to perform a hiding operation or an unloading operation for the loaded control set and the loaded data source of the characteristic region of the first window in an event that an extended region of the first window is displayed currently.

In a specific implementation of the present application, the second loading module 150 may further be configured to retain a loaded control set of the extended region of the first window, and replace a loaded data source of the extended region of the first window with a data source of an extended region of the second window in an event that the extended region of the first window is displayed currently, and the second window that is to be created uses a same control set of the extended region of the first window.

For the ease of description, during description of the system, functions thereof are divided into various modules for individual descriptions. Apparently, when implementing the present application, functions of various modules may be implemented in one or more pieces of software and/or hardware.

Through the description of the foregoing implementations, one of ordinary skill in the art can clearly understand that the present disclosure can be implemented using software with a necessary universal hardware platform. Based on such understanding, the technical solution of the present disclosure in essence or the part which contributes to the existing technologies can be embodied in a form of a software product. The computer software product may be stored in a storage medium, such as a ROM/RAM, a magnetic disk, and an optical disk, etc., and includes instructions for instructing a computing device (which may be a personal computer, a server, a network device, etc.) to perform the method described in each embodiment or parts of the embodiment of the present disclosure.

The embodiments in the specification are described in a progressive manner, identical or similar parts of the embodiments may be obtained with reference to each other. Each embodiment emphasizes an aspect different from other embodiments. Particularly, for the systems or system embodiments, descriptions thereof are relatively simple because they are basically similar to the method embodiments, and relevant parts may be obtained with reference to respective parts of the method embodiments. The systems and system embodiments described above are merely exemplary, and units described as separated components may be or may not be separated physically. Components displayed as units may be or may not be physical units, i.e., may be located at a same location, or may be distributed among multiple network units. Parts or all of the modules may be selected to implement the objective of the technical scheme of an embodiment according to an actual need. One of ordinary skill in the art can understand and implement the present disclosure without any creative effort.

The present application can be applicable to a number of universal or dedicated computing environments or configurations. Examples include a personal computer, a server computer, a handheld device or a portable device, a tablet device, a multi-processor system, a microprocessor-based system, a set-top box, a programmable consumer electronic device, a network PC, a minicomputer, a mainframe computer, or a distributed computing environment that include any of the foregoing system(s) or device(s).

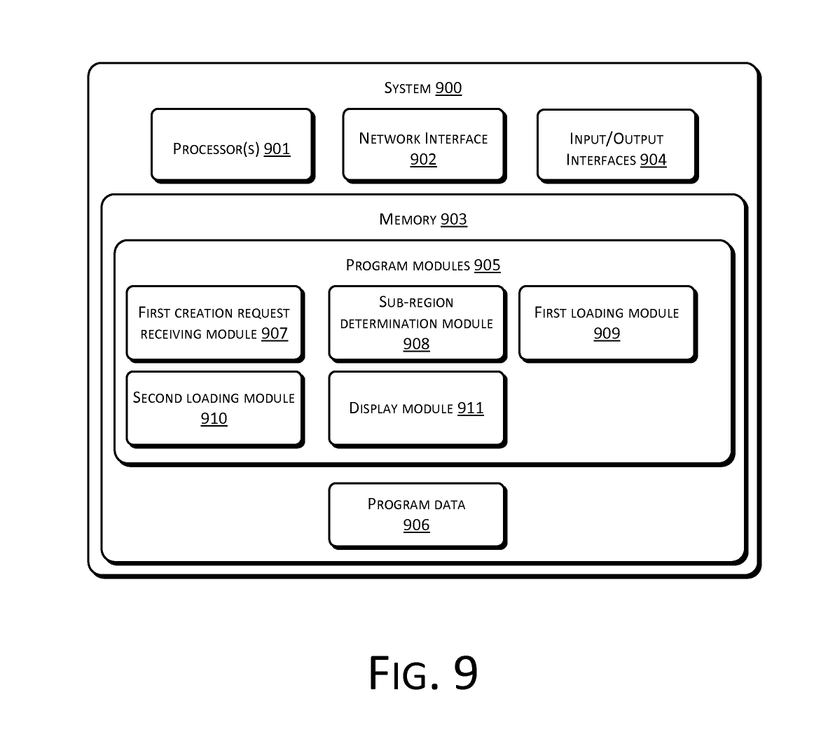

For example, FIG. 9 shows an example system 900, such as the systems as described above, in more detail. In an embodiment, the system 900 may include, but is not limited to, one or more processors 901, a network interface 902, memory 903 and an input/output interface 904.

The memory 903 may include a form of computer readable media, e.g., a non-permanent storage device, random-access memory (RAM) and/or a nonvolatile internal storage, such as read-only memory (ROM) or flash RAM. The memory 903 is an example of computer readable media.

The computer readable media may include a permanent or non-permanent type, a removable or non-removable media, which may achieve storage of information using any method or technology. The information may include a computer-readable command, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

The memory 903 may include program modules 905 and program data 906. In one embodiment, the program modules 905 may include a first creation request receiving module 907, a sub-region determination module 908, a first loading module 909, a second loading module 910 and/or a display module 911. Details of these modules may be found in the foregoing description and are not redundantly described herein.

The foregoing descriptions are merely exemplary implementations of the present application. It should be noted that a person of ordinary skill of the art can make improvements and modifications without departing from the principle of the present application. Such improvements and modifications should be considered as falling within the protection scope of the present application.

1. A window interface display method comprising:
receiving a request for creating a first window, the request including type information of a window to be created and information of a data source to be loaded;
determining sub-regions included in the window to be created based on the type information, wherein the sub-regions include a public region and a characteristic region, the public region includes a same portion of at least two different types of windows, and the characteristic region includes a characteristic portion of each specific type of window that is different from other types of window;
loading respective control sets corresponding to the sub-regions of the first window to be created and respective data sources corresponding to the sub-regions; and
displaying a result of the loading.

2. The method of claim 1, wherein the sub-regions further comprise an extended region, the extended region being configured to provide an extended function for the window, and different types of windows are allowed to have a same extended region control set.

3. The method of claim 1, further comprising receiving a request for creating a second window and determining sub-regions included in the second window when the first window has been displayed currently.

4. The method of claim 3, further comprising:
retaining a loaded control set of the public region of the first window; and
replacing a loaded data source of the public region of the first window with a data source of a public region of the second window.

5. The method of claim 3, further comprising:
performing a hiding operation or an unloading operation on a loaded control set and a loaded data source of the characteristic region of the first window;
loading a control set and a data source of a characteristic region of a second window; and
displaying a new loading result.

6. The method of claim 5, wherein performing the hiding operation or the unloading operation on the loaded control set and the loaded data source of the characteristic region of the first window comprises:
determining whether a switching relationship exists between the second window that is to be created and the first window that is currently displayed based on a service requirement; and
if affirmative, hiding the loaded control set and the loaded data source of the characteristic region of the first window.

7. The method of claim 5, wherein performing the hiding operation or the unloading operation on the loaded control set and the loaded data source of the characteristic region of the first window comprises:
determining whether a replacement relationship exists between the second window that is to be created and the first window that is currently displayed based on a service requirement; and
if affirmative, unloading the loaded control set and the loaded data source of the characteristic region of the first window.

8. The method of claim 5, further comprising performing the hiding operation or the unloading operation on the loaded control set and the loaded data source of the characteristic region of the first window in an event that an extended region of the first window is displayed currently.

9. The method of claim 3, further comprising retaining a loaded control set of an extended region of the first window and substituting a loaded data source of the extended region of the first window with a data source of an extended region of the second window in an event that the extended region of the first window is displayed currently and the second window that is to be created and the first window use a same extended region control set.

10. A window interface display system comprising:
a creation request receiving module, configured to receive a request for creating a first window, the request including type information of a window to be created and information of a data source to be loaded;
a sub-region determination module, configured to determine sub-regions included in the window to be created based on the type information, wherein the sub-regions include a public region and a characteristic region, the public region includes a same portion of at least two different types of windows, and the characteristic region includes a characteristic portion of each specific type of window that is different from other types of window;
a first loading module, configured to load respective control sets corresponding to the sub-regions of the first window to be created and respective data sources corresponding to the sub-regions; and
a display module, configured to display a loading result of the first loading module.

11. The system of claim 10, wherein the sub-regions further comprise an extended region, the extended region being configured to provide an extended function for the window, and different types of windows are allowed to have a same extended region control set.

12. The system of claim 10, wherein the creation request receiving module is further configured to receive a request for creating a second window when the first window is displayed currently.

13. The system of claim 12, further comprising a second loading module that is configured to retain a loaded control set of the public region of the first window, replace a loaded data source of the public region of the first window with a data source of a public region of the second window, perform a hiding operation or an unloading operation for a loaded control set and a loaded data source of the characteristic region of the first window, and load a characteristic control set and a data source of a characteristic region of the second window, wherein the display module is further configured to display a loading result of the second loading module.

14. The system of claim 12, further comprising a second loading module that is configured to perform a hiding operation or an unloading operation on a loaded control set and a loaded data source of the characteristic region of the first window when an extended region of the first window is displayed currently.

15. The system of claim 12, further comprising a second loading module that is configured to retain a loaded control set of an extended region of the first window, and substitute a loaded data source of the extended region of the first window with a data source of an extended region of the second window in an event that the extended region of the first window is displayed currently, and the second window that is to be created and the first window use a same extended region control set.

16. One or more computer-readable media storing executable instructions that, when executed by one or more processors, cause the one or more processors to perform acts comprising:
receiving a request for creating a first window, the request including type information of a window to be created and information of a data source to be loaded;
determining sub-regions included in the window to be created based on the type information, wherein the sub-regions include a public region and a characteristic region, the public region includes a same portion of at least two different types of windows, and the characteristic region includes a characteristic portion of each specific type of window that is different from other types of window;
loading respective control sets corresponding to the sub-regions of the first window to be created and respective data sources corresponding to the sub-regions; and
displaying a result of the loading.

17. The one or more computer-readable media of claim 16, wherein the sub-regions further comprise an extended region, the extended region being configured to provide an extended function for the window, and different types of windows are allowed to have a same extended region control set.

18. The one or more computer-readable media of claim 16, the acts further comprising:
receiving a request for creating a second window and determining sub-regions included in the second window when the first window has been displayed currently;
retaining a loaded control set of the public region of the first window;
replacing a loaded data source of the public region of the first window with a data source of a public region of the second window;
performing a hiding operation or an unloading operation on a loaded control set and a loaded data source of the characteristic region of the first window;
loading a control set and a data source of a characteristic region of a second window; and
displaying a new loading result.

19. The one or more computer-readable media of claim 18, wherein performing the hiding operation or the unloading operation on the loaded control set and the loaded data source of the characteristic region of the first window comprises:
determining whether a switching relationship exists between the second window that is to be created and the first window that is currently displayed based on a service requirement; and
if affirmative, hiding the loaded control set and the loaded data source of the characteristic region of the first window.

20. The one or more computer-readable media of claim 18, wherein performing the hiding operation or the unloading operation on the loaded control set and the loaded data source of the characteristic region of the first window comprises:
determining whether a replacement relationship exists between the second window that is to be created and the first window that is currently displayed based on a service requirement; and
if affirmative, unloading the loaded control set and the loaded data source of the characteristic region of the first window.
